(19) United States
(12) Patent Application Publication
(10) Pub. No.: US 2007/0199768 A1
(43) Pub. Date: Aug. 30, 2007

(54) Universal ladder stand dolly system

(76) Inventors: David James Duke, Oregon, IL (US); Kerry Stephen Kalchbrenner, Davis Junction, IL (US)

Correspondence Address: DAVID JAMES DUKE, 310 ALDRIN STREET, OREGON, IL, 61061, US

(21) Appl. No.: 11/584,910

(22) Filed: Oct. 23, 2006

Related U.S. Application Data
(60) Provisional application No. 60/776,781, filed on Feb. 24, 2006.

(51) Int. Cl. E06C 1/00

(52) U.S. Cl. 182/21

(57) ABSTRACT

A ladder dolly engagable to multiple styles of ladders. The dolly comprises two separate tubular bodies with each having at least one side shorter than the other sides. Two horizontal members extending from sides perpendicular to the shorter side and outwardly extend past the shorter side. Multiple holes are spaced in the outwardly extended ends of the horizontal members, whereby allowing securement to various sizes of ladder rungs. Each pair of horizontal members includes a pin engagable between corresponding holes for securing each tubular body to a ladder rung. An axle is attached to one side perpendicular to the shorter side of one tubular body and extends outwardly in the opposite direction of the shorter side. A second axle is attached to the opposite perpendicular side of the second tubular body and also extends outwardly past the shorter side. Each axle rotatably supports a wheel on the outwardly extended end.

### CROSS-REFERENCE TO RELATED APPLICATIONS

This application claims the benefit of provisional patent application Ser. No. 60/776,781 filed 2006 Feb. 24 by the present inventors.

### FEDERALLY SPONSORED RESEARCH

Not Applicable

### SEQUENCE LISTING FOR PROGRAM

Not Applicable

### FIELD OF INVENTION

This invention relates to dollies and dolly systems, specifically to dolly systems for transporting a ladder or a hunter's ladder stand.

### PRIOR ART

It is known that manufacturers have been developing and selling ladder stands for the hunting industry. Some ladder stands have been developed with a dolly system as well. Furthermore, dollies have been invented to specifically carry ladders. However, the applicants are unaware of a dolly or dolly system designed to carry multiple types, styles, and sizes of ladder stands without modifying the user's ladder stand. The applicants are also unaware of a dolly that can be stowed conveniently away in a compact hunter's pack.

Although many conventional ladder stands are designed to come apart for easier portability, they simply are awkward for a user to easily and comfortably carry the entire ladder stand for long distances. In addition to the awkwardness of carrying the collapsed ladder stand, the weight of such ladder stands range anywhere from 35 pounds to over 150 pounds. If a hunter wishes to set up two or more ladder stands during any given day, the task can become very taxing to his/her body. Thus, limiting the distance to which one can comfortably carry and set up a multitude of ladder stands. In addition to the strains caused by carrying a ladder stand over rough terrain, ladder stand sections have a tendency to get caught on brush and hanging limbs while carrying the stand. This causes a lot of noise making it more difficult to set up a hunting location without spooking the hunted game.

Inventors have been trying to solve this problem by developing versions of a ladder stand with some type of dolly system incorporated—for example, in U.S. Pat. No. 6,860,364 to Deemer (2005), U.S. Pat. No. 6,811,180 to Molliere (2004), U.S. Pat. No. 6,186,271 to Borries (2001), U.S. Pat. No. 5,839,538 to Magyar (1998), U.S. Pat. No. 5,295,556 to Mullin (1994), U.S. Pat. No. 5,105,908 to Freund (1992), U.S. Pat. No. 3,336,999 to McSwain (1967), and U.S. Pat. No. 3,282,375 to Ray (1996). Although all the above dollies work effectively for transporting their respective ladder stands, the inventors of the above ladder stands designed the dolly portions to fit primarily for the ladder stands mentioned in the patents. Thus, the usefulness of these dolly systems for existing ladder stands from multiple manufacturers one might own is moot.

U.S. Pat. No. 5,433,291 to Shoestock (1995) shows a combination wheeled cart and self climbing tree stand. This invention was designed for use by a user to tow the tree stand to their desired location and climb the tree once the wheels and axle have been removed. The wheeled portion of the invention is designed with a single axle extending the width of the tree stand. For this reason alone, the Shoestock design would not work with a multitude of conventional ladder stands. The set width of the single axle does not allow for installation to various ladder stands of assorted widths.

U.S. Pat. No. 5,887,676 to Harbin (1999) shows an accessory kit which allows a tree stand to be pulled into the woods and for the tree stand to double as a game carrier. The accessory kit includes a set of wheels and a series of brackets with bolts allowing the wheels to be attached to the tree stand. With the Harbin invention, a user must drill holes in his/her tree stand and then attach the brackets and wheels. This would cause four or more new holes in a tree stand that will rust after a period of time. This invention will also require the user to be mechanically proficient ensuring no unnecessary mistakes occur when drilling into his/her tree stand. Additionally, a user would be required to purchase multiple accessory kits and modify all of his/her tree stands for this invention. Thus, the cost for a user owning two or more tree stands could become very high.

U.S. Pat. No. 4,049,283 to Brookes (1997) shows a two-axled, two-wheeled dolly system for transporting extension ladders. This invention is designed for large construction style ladders but is not feasible for a hunter's ladder stand. The two wheeled carriage spans nearly the width of a ladder. The ladder is supported on the carriage with two additional transverse pieces. The combination of the wide single carriage and the ladder supports creates excess bulk for a hunter while carrying the device out of a wooded area. This invention is not compactable and simply too bulky for use by a hunter.

### OBJECTS AND ADVANTAGES

Accordingly, several objects and advantages of the present invention are:
a) to provide a dolly system that can be manufactured to fit multiple styles, shapes, and sizes of ladder stands;
b) to provide a dolly system which can be quickly and easily installed and taken off of multiple styles, shapes, and sizes of ladder stands without the use of tools;
c) to provide a dolly system that is durable enough to withstand the weight of a ladder stand and the burdens of being pulled across rough terrain;
d) to provide a dolly system that is compact and light-weight, whereby allowing a person to stow the system away in a hunter's pack or compact storage device when not in use; and
e) to provide a dolly system that does not require a user to modify the structure of his/her ladder stand in anyway.

Further objects and advantages are to provide a ladder stand dolly system which will allow the elderly or physically weaker users to transport a ladder stand in and out of a wooded area more easily and with less bodily strain. Even further objects are to provide a dolly system which is simple to operate and will bear the weight of a human or large game animal such as a deer when used in conjunction with a ladder section.

Still further objects and advantages will become apparent from a consideration of the ensuing description and drawings.

### SUMMARY

In accordance with the present invention, a universal ladder stand dolly system comprises two tubular bodies with each having a void in one end of one side, two horizontal securing members on each tubular body, multiple rung securement holes on each securing member, a pin or securement mechanism for attaching the dolly system to a ladder rung, and wheels mounted on axles attached to each tubular body.

### DRAWINGS—FIGURES

FIG. 1 shows a hunter towing a ladder stand with a universal ladder stand dolly system attached.

FIG. 2 is a perspective view of the left side (part A) of a universal ladder stand dolly system without a wheel.

FIG. 3 is a perspective view of the right side (part B) of a universal ladder stand dolly system without a wheel.

FIG. 4 shows an alternative embodiment of the left side (part A) of a universal ladder stand dolly system.

FIG. 5 shows an alternative embodiment of the right side (part B) of a universal ladder stand dolly system.

FIG. 6 shows part A dolly system applied to a section of a ladder stand.

### DRAWINGS—REFERENCE NUMERALS

H User
L Ladder Stand
111 Dolly wheel
231 Tubular body
231a Ladder rung cradle side
231b Tubular body second side
231c Tubular body third side
231d Tubular body wheel side
232 Locking arm
232a Rung securement hole
233 Ladder rung cradle
234 Hitch pin
235 Axle
236 Axle bushing
237 Washer
238 Cotter pin
455 Alternative axle
456 Axle support bracket

### DETAILED DESCRIPTION—PREFERRED EMBODIMENT

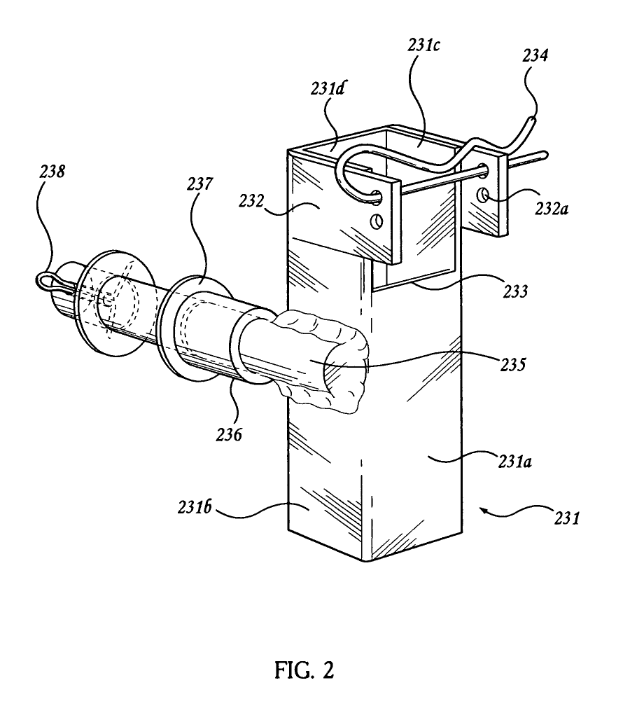

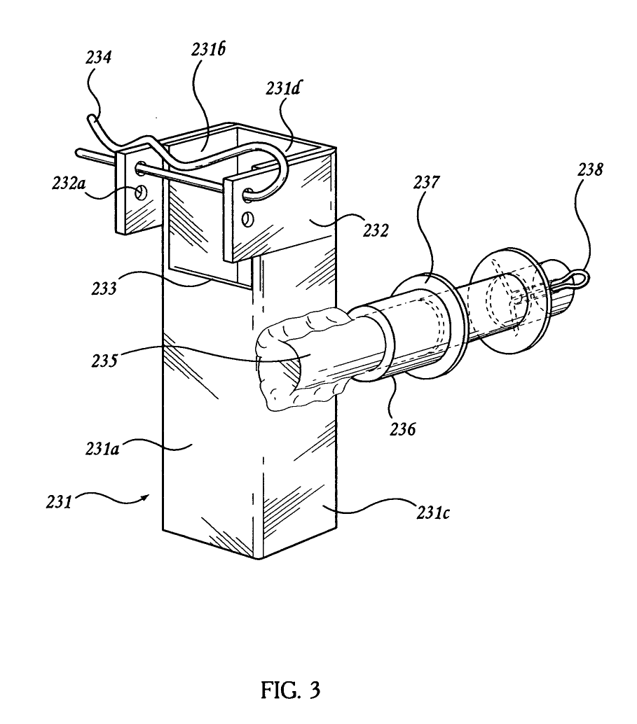

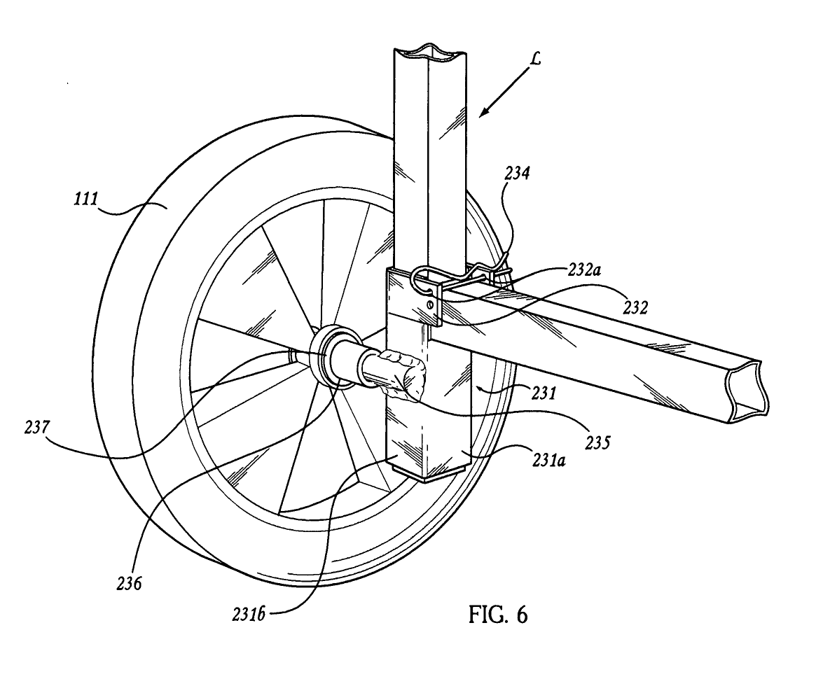

Referring now to FIGS. 2, 3 and 6, there is seen a preferred embodiment of parts A and B of a universal ladder stand dolly system. FIGS. 2 and 3 are shown without the wheel 111 attached for a more detailed image of the structure. FIG. 6 shows only part A of the dolly system because part B is simply the same view on the opposite ladder leg and rung.

The dolly system is a two part dolly the inventors presently prefer made with elongated square tubular bodies 231, approximately 3 inches to 4 inches long as the skeletal base, and constructed with steel or aluminum. However, a strong rigid material capable of enduring hardships of weather, severe temperature changes, rough abuse, heavy weight, and the frictions of constantly sliding ladder legs in and out of the tubular body 231 can be used.

At one end of each tubular body 231 is a void created by having one side of the tubular body 231 shorter than the other sides. The bottom of the void is referred to as the ladder rung cradle 233. The inventors currently prefer the ladder rung cradle 233 made by cutting or grinding an end portion of one side wall away from the rest of the tubular body 231. The cradle 233 is typically the same width as the width of the tubular body side 231a in which the cradle 233 is on. The ladder rung cradle 233 will allow a ladder rung to rest thereon when a ladder leg passes through the tubular body 231.

On the same end of the tubular body 231 as the previously mentioned void, from here on being referred to as the top end, a pair of rigid horizontal members 232, also referred to as locking arms 232, extend from both perpendicular sides 231b and 231c of the ladder rung cradle side 231a on each tubular body 231. Each locking arm 232 horizontally extends outward in the direction of the ladder rung cradle side 231a. Each locking arm 232 also includes multiple rung securement holes 232a vertically spaced apart near the end of the locking arm 232 outwardly extended.

Now referring to a dolly part A in FIG. 2, the universal ladder stand dolly system includes an axle 235 horizontally mounted to a tubular body second side 231b approximately half way down the tubular body 231 and extending outward past the tubular body wheel side 231d. Currently, the applicants prefer the axle 235 to be permanently welded. A hole is drilled in the outwardly extended end of the axle 235 to allow a cotter pin 238 to pass through once an axle bushing 236, wheel 111, and two washers 237 have been installed.

Now referring to a dolly part B in FIG. 3, a second axle 235 is horizontally welded to a tubular body third side 231c approximately half way down the tubular body 231 and extending outward past the tubular body wheel side 231d. A hole is drilled in the outwardly extended end of the axle 235 to allow a pin 238 to pass through once the axle bushing 236, wheel 111, and two washers 237 have been installed.

Referring now to dolly parts A and B in FIGS. 2 and 3 respectively, slide an axle bushing 236 onto each axle 235 from the outer end of each axle 235 until the bushings 236 touch the tubular bodies 231. Slide a single washer 237 onto each axle 235 until the washer 237 touches the axle bushing 236. Slide a tubeless rubber wheel 111, preferably twelve inches in diameter, onto each axle 235 until the wheels 111 touch the previously installed washers 237. Slide an additional washer 237 onto each axle 235 until the washers 237 touch the wheels 111. Lastly, insert a cotter pin 238 into the hole at the outer ends of each axle 235 whereby securing the wheels 111 to the axles 235.

### Operation—Preferred Embodiment

In operation, one uses a universal ladder stand dolly system by:
1. With a universal ladder stand dolly system part A, ensure the tubular body second side 231b is facing the user H and the tubular body 231 is upright as in FIG. 2. With a single ladder section of a ladder stand, the user H will lay the ladder flat on the ground in front of him/her and slide the dolly system part A up from the bottom of the ladder stand left leg until the first ladder rung touches the ladder rung cradle 233. Insert the hitch pin 234 through the first available rung securement hole 232a viewable above the ladder rung and extend the securement pin 234 to the corresponding rung securement hole 232a in the opposite locking arm 232 of the dolly system part A.
2. With a universal ladder stand dolly system part B, ensure the tubular body third side 231c is facing the user H and the tubular body 231 is upright as in FIG. 3. With the right ladder leg, slide the dolly system part B up from the bottom of the ladder stand leg until the first ladder rung touches the bottom of the ladder rung cradle 233. Insert a hitch pin 234 through the first available rung securement hole 232a viewable above the ladder rung and extend the securement pin 234 to the corresponding rung securement hole 232a in the opposite locking arm 232 of the dolly system part B.

The remaining rung securement holes 232a viewable in the locking arms 232 are for varying sizes of ladder rungs.

The universal ladder stand dolly system is now secured to a ladder section of a ladder stand and the remaining sections of the ladder stand can now be attached to the ladder section holding the dolly system.

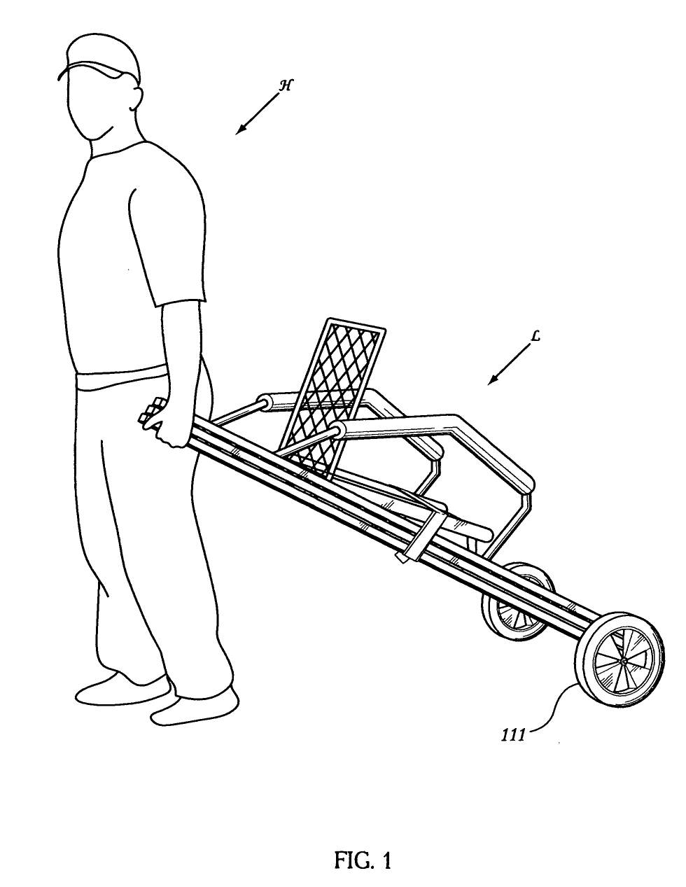

The user H will use the straps and/or rope provided by the ladder stand manufacturer to tie and/or strap the remaining ladder stand sections to the section holding the dolly system. The dolly system axles 235 will face the ground and the remaining sections secured to the opposite side. The user H should connect the seat and platform sections as close to the dolly system end of the ladder stand as possible, whereby keeping much of the weight off of the user H and alternatively placing the weight onto the dolly system. Once all ladder stand sections have been secured to each other, the user H will pull the ladder stand behind him/her to their desired location as seen in FIG. 1. The ladder stand is to be grasped by one or both ladder legs on the opposite end as the dolly system and pulled behind the user H.

Once the user H has reached his/her desired location, removing the universal ladder stand dolly system is done in the reverse order of installation. The user will untie and/or unstrap the ladder stand sections and place them on the ground. Once the section of ladder stand holding the dolly system has been removed from the other ladder stand sections, the dolly system will be taken off by removing each hitch pin 234 from the locking arms 232 on each dolly part A and B. Slide both dolly parts A and B off of the ladder legs and replace the securement pins 234 to the locking arms 232 for storage. The universal ladder stand dolly system can now be stowed away in a small case or back pack.

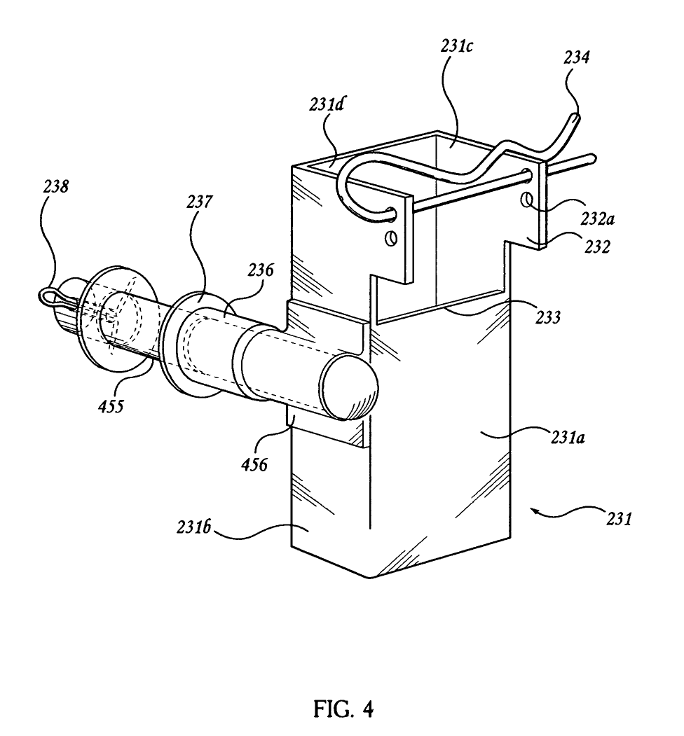

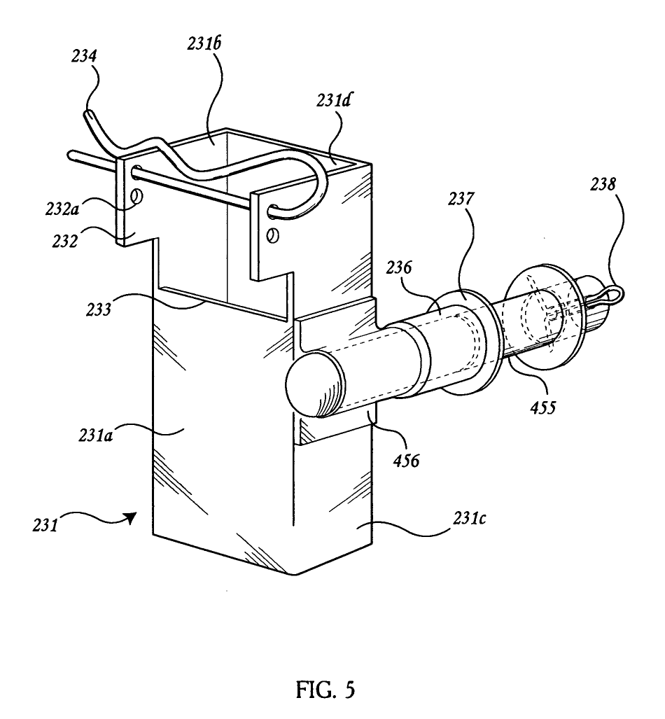

### FIGS. 4 and 5—Alternative Embodiment

There are additional possibilities in regards to functional embodiments of the current invention. FIGS. 4 and 5 show the alternative tubular body 231 as being rectangular in shape.

The locking arms 232 are an extension of the perpendicular sides 231b and 231c of the ladder rung cradle 233.

The axles 455 are housed in axle support brackets 456. The axle support brackets 456 are attached to sides 231b and 231c of dolly parts A and B respectively. With the support brackets 456 in place, the user H will insert an alternative axle 455 from the end closest to the ladder rung cradle side 451a and extend the axle 455 through the opposite end of the support bracket 456. Having a rounded or bolt type end for the axle 455 would allow the alternative axle 455 to pass in and out of the bracket 456 without passing all the way through. This will provide for a more compact storage alternative if the user H so desires.

The user H will now install the axle bushings 236, wheels 111, washers 237, and cotter pins 238 from the outwardly extended end of the alternative axle 455.

### Operation—Alternative Embodiment

In operation, one uses the universal ladder stand dolly system with the alternative embodiment generally the same as described above in the preferred embodiment operation. However, the rectangular tubular body 231 would allow a user H to install the dolly system on a ladder stand with rectangular ladder legs as well as on a ladder stand with square ladder legs.

If the user H has a ladder stand with square ladder legs, he/she will install the rectangular body 231 parts A and B, as seen in FIGS. 4 and 5, onto two sections of a ladder stand.

The user H will stack two sections of a ladder stand, one on top of the other, in front of him/her and lay them on the ground. The user H will then slide the dolly system part A up from the bottom of the left side ladder legs ensuring the dolly part A encumbers both ladder legs of each ladder section. Once the first ladder rung of each ladder stand section has touched the ladder rung cradle 233, the user H will secure the dolly part A to the ladder sections with a hitch pin 234 or other securement pin.

With the dolly part A installed, the user H will then install dolly system part B to the right side of the ladder legs in the same manner as he/she did with dolly system part A.

With both dolly parts A and B installed, the user H will attach the remaining ladder stand sections to the ladder stand holding the dolly system. Attachment procedures are performed by securing each ladder stand section to one another with the straps and/or rope provided by the ladder stand manufacturer.

### Advantages

From the description above, a number of advantages of the universal ladder stand dolly system are evident:
a) Conventional and older ladder stands will be easier to transport into a wooded area without the user having to bear the full weight of the ladder stand. Stress and strains to a user's body will be greatly improved.
b) The two piece dolly employing short single axles allow convenient storage of the dolly system when not in use.
c) The extension of the locking arms along with the holes in the outer ends allow a user to secure the dolly parts using a single securement means without the use of tools. This enables the ladder to remain in the original form without a user modifying his/her ladder.
d) Using a tube with a void in one side allows the dolly to telescope up a ladder leg and to prevent twisting once a ladder rung has been seated in the voided area. This design allows varying sizes of ladders to be used.
e) Consumers will be more apt to purchase more ladder stands because of the ladder stand dolly systems ease of use. Manufacturers and retailers will have a higher sales volume with ladder stands.

### CONCLUSION, RAMIFICATIONS, AND SCOPE

Accordingly, the reader will see that a universal ladder stand dolly system can be used to transport multiple styles, shapes and sizes of ladder stands over rough terrain, and it can also withstand the burdens caused by harsh weather and heavy weight. In addition, using only a single pin on each dolly part to attach the universal ladder stand dolly system shows the simplicity of use without the user having to employ tools.

Furthermore, using two separate short axle parts, instead of using a single elongated axle extending the width of a ladder stand, allows a user to conveniently stow a complete universal ladder stand dolly system in a small pack when not in use. Additionally, the use of a two part dolly allows a user to apply the dolly system to varying widths of ladder stands.

While the above description contains many specificities, these should not be construed as limitations on the scope of the invention, but as exemplifications of the presently preferred embodiment thereof. Many other ramifications and variations are possible within the teachings of the invention.

For example, the preferred embodiment describes the wheels 111 to be a twelve inch tubeless wheel 111. While this is the size the inventors currently prefer, a larger or smaller wheel could be used.

While a detailed description of the axles has been provided, the design of axle parts can be varied. The inventors primary concern is to have axles rotatably supporting wheels to sides perpendicular to the ladder rung cradle side. Thus the scope of the invention should be determined by the appended claims and their legal equivalents, rather than by the examples given.

We claim:

1. A detachable dolly system suitable for transporting a ladder stand comprising;
a) a first elongated tubular body having four sides with one side a predetermined length shorter therewith;
b) a second elongated tubular body having four sides with one side a predetermined length shorter therewith;
c) a first wheel support laterally secured to one perpendicular side of said shorter side on said first tubular body, said wheel support extending outwardly in opposite direction as said shorter side;
d) a second wheel support laterally secured to said second tubular body on opposite perpendicular side as said first wheel support, said second wheel support extending outwardly in opposite direction as said shorter side;
e) a first wheel rotatably mounted to said first wheel support;
f) a second wheel rotatably mounted to said second wheel support;
g) a first pair of horizontal members including a first member and second member laterally extending outward from perpendicular sides of said first tubular body thereon;
h) a second pair of horizontal members including a first member and second member laterally extending outward from perpendicular sides of said second tubular body thereon;
i) a removable securement means engagable between corresponding said holes on each pair of said first and second horizontal members therewith, whereby allowing a user to manually secure said tubular bodies to a ladder rung.

2. A dolly system according to claim 1, wherein said horizontal members extend outwardly in direction of said shorter side of said first and second tubular body.

3. A dolly system according to claim 1, wherein said horizontal members include a plurality of holes vertically spaced on outwardly extended ends, said holes of one said horizontal member on each said first and second tubular body being in registry with holes of opposite said horizontal member on respective said tubular body.

4. A dolly system according to claim 1, wherein said securement means extends from one said horizontal member to opposite said horizontal member of said horizontal member pair therewith, said securement means extends above a ladder rung when said ladder rung is seated between said perpendicular sides of said shorter side and said ladder rung also seated in said shorter side on said first and second tubular body, whereby securing said dolly system to a ladder thereon.

5. A two piece dolly suitable for transporting a ladder over rough terrain comprising;
a) a first and second telescoping body with each said body having a void in one side, each said body also having a first and second side with each said side being oppositely perpendicular to said voids therewith;
b) a first wheel support secured to said first perpendicular side of said first telescoping body, said wheel support horizontally extending outward beyond opposite side of said void;
c) a second wheel support secured to said second perpendicular side of said second telescoping body, said wheel support horizontally extending outward beyond opposite side of said void;
d) a first wheel rotatably mounted to said first wheel support;
e) a second wheel rotatably mounted to said second wheel support;
f) a first and second pair of horizontal members laterally extending outward from said first and second side on each said first and second telescoping body and extending beyond said voids, each said member having a plurality of holes in outwardly extended ends;
g) a removable securement means engagable between each pair of said horizontal members, whereby each said telescoping body can be secured to a ladder when a ladder leg passes trough said bodies.

6. A dolly system according to claim 5, wherein said telescoping body is constructed of rigid material.

7. A dolly system according to claim 5, wherein said telescoping body is adaptably constructed to encumber the outer portion of a ladder leg.

8. A dolly for transporting a ladder over rough terrain comprising;
a) a first and second hollow rigid tube, each said tube having one side a predetermined length shorter than the other sides;
b) a pair of rigid members outwardly extending from sides perpendicular to said shorter sides on each said first and second hollow tube thereon;
c) a plurality of holes vertically spaced near outwardly extended ends of said rigid members therewith;
d) a securement means engagable between said rigid member pairs on each said first and second hollow rigid tube;
e) a wheel and axle combination rotatably affixed to each said first and second tube;
f) wherein said shorter side seats a ladder rung when said first and second hollow tube slides over a ladder leg and telescopes to a first ladder rung thereon;
g) wherein said securement means extends over the upper portion of a ladder rung when said ladder rung is seated within said shorter side;

9. A dolly according to claim 8, wherein said holes of each pair of said rigid members is spaced in registry with the holes in opposite said rigid member of the pair therewith.

10. A dolly according to claim 8, wherein said rigid members extend outwardly in direction of said shorter side.
